(19) United States
(12) Patent Application Publication
(10) Pub. No.: US 2001/0021044 A1
(43) Pub. Date: Sep. 13, 2001

(54) Method for monitoring optical transmission path and optical fiber amplification repeater used in the method

(76) Inventor: Siak Pin Lim, Tokyo (JP)

Correspondence Address: McGinn & Gibb, PLLC, 8321 Old Courthouse Road, Suite 200, Vienna, VA, 22182-3817, US

(21) Appl. No.: 09/798,937

(22) Filed: Mar. 6, 2001

(30) Foreign Application Priority Data
Mar. 8, 2000 (JP) 2000-063121

(51) Int. Cl. H04B 10/08; H04B 10/16

(52) U.S. Cl. 359/110; 359/179

(57) ABSTRACT

An optical fiber amplification repeater system used in the method are provided which enable monitoring of the optical transmission paths with high accuracy without degradation of transmission characteristics of main signal light and with reduced loss of backward scattering light, in wavelength division multiplexing transmission.

In the optical fiber amplification repeater system in which main signal light is received and transmitted between optical wavelength multiplexing end ports through optical fiber amplification repeaters each having upward and downward repeater circuits including an optical fiber amplifier mounted in a pair of upward and downward optical transmission paths and the optical wavelength multiplexing end port having monitoring devices to receive and transmit monitoring optical pulse are provided and optical circulator and optical fiber grating are connected to the optical fiber amplifier. Backward scattering light is guided through the optical circulator to the optical grating and only the backward scattering light of the monitoring optical pulse is output to an opposite optical transmitter path to feed it to the monitoring devices.

The present application claims priority of Japanese Patent Application No.2000-063121 filed on Mar. 8, 2000, which is hereby incorporated by reference.

### BACKGROUND OF THE INVENTION

1. Field of the Invention

The present invention relates to a method for monitoring states of optical fiber transmission paths in an optical amplification repeater system in which a plurality of optical fiber amplification repeaters are mounted in an upward transmission path and in a downward transmission path and a light signal is received and transmitted through the upward and downward transmission paths between optical wavelength multiplexing end ports.

2. Description of the Related Art

An example of conventional in-service monitoring technologies will be described by referring to FIG. 4 in which a state of an optical fiber transmission path is monitored by propagating a monitoring optical pulse through the optical transmission path and by using backward scattering light of the monitoring optical pulse reflected off a place where a coated optical fiber has been broken. FIG. 4 is a schematic block diagram showing configurations of an optical amplification repeater system employing a conventional optical transmission path monitoring device. A transmission of optical signals from an optical wavelength multiplexing end port 1 to an optical wavelength multiplexing end port 11 is defined as an upward transmission and a transmission of optical signals from the optical wavelength multiplexing end port 11 to the optical wavelength multiplexing end port 1 is defined as a downward transmission. In FIG. 4, the reference number of parts related only to the upward transmission is accompanied with a symbol “a”, while the reference number of parts related only to the downward transmission is accompanied with a symbol “b”.

As shown in FIG. 4, the optical wavelength multiplexing end port 1 is connected to the optical wavelength multiplexing end port 11 through a plurality of optical fiber amplification repeaters 10, 10, . . . , by a pair of optical transmission paths including an upward optical transmission path 4a and a downward optical transmission path 4b and these optical wavelength multiplexing end ports 1 and 11, optical fiber amplification repeaters 10, 10, . . . , and transmission paths 4a and 4b make up the optical amplification repeater system. A monitoring device 2, in order to monitor the upward optical transmission path 4a in the optical amplification repeater system, is provided with a transmitter section 2a used to transmit a monitoring optical pulse having a specified wavelength, a receiver section 2b used to receive the monitoring optical pulse having a specified wavelength and a measuring section (not shown). Similarly, a monitoring device 12, in order to monitor the downward optical transmission path 4b in the optical amplification repeater system, is provided with a transmitter section 12a used to transmit a monitoring optical pulse having a specified wavelength and a receiver section 12b used to receive the monitoring optical pulse having a specified wavelength and a measuring section (not shown). Preferably, the wavelength of the monitoring optical pulse used for monitoring the upward optical transmission path 4a is different from that used for monitoring the downward optical transmission path 4b.

The optical wavelength multiplexing end port 1 is made up of a transmitting section 1a used to transmit main signal light, a receiving section 1b used to receive the main signal light, an optical multiplexer 3a used to multiplex the main signal light fed from the transmitting section 1a and the monitoring optical pulse for monitoring the upward transmission path 4a fed from the transmitter section 2a in the monitoring device 2 together and to transmit the multiplexed light to the upward optical transmission path 4a to be monitored and an optical demultiplexer 3b used to demultiplex the multiplexed light to feed the main signal light to the receiving section 1b and a monitoring light component to the receiver section 2b in the monitoring device 2. Similarly, the optical wavelength multiplexing end port 11 is made up of a transmitting section 11b to transmit main signal light, a receiving section 11a to receive main signal light, an optical multiplexer 13b to multiplex the main signal light fed from the transmitting section 11b and the monitoring optical pulse for monitoring the downward optical transmission path 4b fed from the transmitter section 12b of the monitoring device 12 together and to transmit the multiplexed light to the downward optical transmission path 4b to be monitored and an optical demultiplexer 13a used to demultiplex the multiplexed light to feed the main signal light to the receiving section 11a and a monitoring light component to the receiver section 12a in the monitoring device 12.

Each of the optical fiber amplification repeaters 10, 10, . . . , is made up of, if classified roughly, an upward repeater circuit and a downward repeater circuit. The upward repeater circuit includes an optical fiber amplifier 5a used to optically amplify output light obtained by multiplexing the main signal light fed from the optical multiplexer 3a of the optical wavelength multiplexing end port 1 and the optical pulse for monitoring the upward optical transmission path 4a together and an optical coupler 6a used to receive output light from the optical fiber amplifier 5a and to transmit the light to the upward optical transmission path 4a to be monitored and, at the same time, to receive backward scattering light fed from upward the optical transmission path 4a and to transmit it through the optical path 9 to the optical coupler 6b mounted in the opposite downward optical transmission path 4b. The downward repeater circuit includes an optical fiber amplifier 5b used to optically amplify output light obtained by multiplexing the main signal light fed from the optical multiplexer 13b in the optical wavelength multiplexing end port 11 and the optical pulse for monitoring the downward optical transmission path 4b together and an optical coupler 6b used to receive output light from the optical fiber amplifier 5b and to transmit the light to the downward optical transmission path 4b to be monitored and, at the same time, to receive backward scattering light fed from the downward optical transmission path 4b and to transmit it through an optical path 9 to an optical coupler 6a mounted in the opposite upward optical transmission path 4a.

Operations of the conventional in-service monitoring of the upward optical transmission path 4a will be described below by referring to FIG. 4. Wavelength multiplexed main signal light fed from the transmitting section 1a and a monitoring optical pulse having a specified wavelength for monitoring the upward light transmission path 4a fed from the transmitter section 2a are multiplexed together by the optical multiplexer 3a in the optical wavelength multiplexing end port 1 and the multiplexed light is output to the upward optical transmission path 4a. The optical fiber amplifier 5a optically amplifies the multiplexed light so as to maintain it at a specified level and transmits the amplified light to the optical coupler 6a. The optical coupler 6a receives both the multiplexed light from the optical fiber amplifier 5a and backward scattering light fed from the opposite downward optical transmission path 4b and outputs them to the upward optical transmission path 4a.

The monitoring light component contained in the backward scattering light which has been reflected off and has returned through the opposite downward optical transmission path 4b to the optical wavelength multiplexing end port 1 is demultiplexed by the optical demultiplexer 3b and is received by the receiver section 2b in the monitoring device 2. By measuring, in the monitoring device 2 (at a measuring section), time elapsed between transmission of the monitoring optical pulse by the transmitter section 2a and receipt of the backward scattering light of the monitoring optical pulse by the receiver section 2b and/or a ratio of an output of the monitoring light pulse to that of the backward scattering light, a position of a failure and/or loss of light in the upward optical transmission path 4a can be detected.

Since operations of the conventional in-service monitoring of the downward optical transmission path 4b are the same as those for the upward optical transmission path 4a, their descriptions are omitted. Moreover, by using the monitoring optical pulse for the downward optical transmission path 4b having a wavelength being different from that of the monitoring optical pulse for the upward optical transmission path 4a, both the upward optical transmission path 4a and downward optical transmission path 4b can be simultaneously monitored in the in-service manner.

In the conventional optical transmission path monitoring device, an output port of the optical fiber amplifier 5a for the upward optical transmission path 4a in the optical fiber amplification repeater 10 is connected to an input port of the optical coupler 6a, while an output port of the optical fiber amplifier 5b for the downward optical transmission path 4b in the optical fiber amplification repeater 10 is connected to an input port of the optical coupler 6b and further another input port of the optical coupler 6a is connected to another input port of the optical coupler 6b in order to guide the backward scattering light to the opposite downward or upward optical transmission path 4b, 4a.

However, the conventional technology has following problems. That is, in a WDM (Wavelength Division Multiplexing) transmission, to increase a total transmission capacity, it is necessary to configure the optical amplifier so as to have a wide bandwidth and so as to produce a high output. To implement the high-power type optical amplifier, loss of the main signal light in the optical couplers 6a and 6b has to be reduced. As a result, since the loss of the backward scattering light generated when it passes through the optical couplers 6a and 6b becomes large, to monitor a state of the optical transmission path including an input port of the optical fiber amplification repeater 10 at high distance-resolution in a long transmission distance, averaging processing to be performed on a received feeble monitoring light signal over a considerably long time is required.

### SUMMARY OF THE INVENTION

In view of the above, it is an object of the present invention to provide a method for monitoring optical transmission paths and optical fiber amplification repeaters used in the method, which enable monitoring of the optical transmission paths with high accuracy without degradation of transmission characteristics of main signal light and with reduced loss of backward scattering light, in wavelength division multiplexing transmission.

According to a first aspect of the present invention, there is provided a method for monitoring optical transmission paths in an optical amplification repeater system in which main signal light is received and transmitted between optical wavelength multiplexing end ports through an optical fiber amplification repeater provided with upward and downward repeater circuits each having an optical fiber amplifier mounted in each of a pair of upward and downward optical transmission paths, the method including steps of:

mounting, on both of the optical wavelength multiplexing end ports, monitoring devices including, at least, one receiving unit and one transmitting unit used to receive and transmit a monitoring optical pulse to be multiplexed together with the main signal light;

mounting, on an output port of each of optical fiber amplifiers in the upward and downward repeater circuits, an optical circulator and an optical fiber grating;

guiding, by using the main signal light and monitoring optical pulse transmitted from the optical circulator, backward scattering light generated while the main signal light and monitoring optical pulse are propagating through the optical transmission path, to the optical fiber grating through the optical circulator; and

transmitting only backward scattering light of the monitoring optical pulse having a specified wavelength by using the optical fiber grating to an opposite optical transmission path.

In the foregoing, a preferable mode is one wherein only a monitoring light component having a specified wavelength out of the backward scattering light is reflected off the optical fiber grating and a monitoring light component having other wavelength and the main signal light pass through the optical fiber grating and are dispersed by a non-reflection terminating section.

Also, a preferable mode is one wherein the backward scattering light of the monitoring optical pulse output to an opposite optical transmission path is multiplexed together with main signal light being transmitted through the opposite optical transmission path by an optical multiplexer mounted in the opposite optical transmission path and is transmitted through the optical fiber amplifier and optical circulator to the receiving unit in the monitoring device.

Also, a preferable mode is one wherein backward scattering light of the monitoring optical pulse output to the opposite optical transmission path is multiplexed together with main signal light being transmitted in the opposite optical transmission path which has been amplified by an optical amplifier mounted in the opposite optical transmission path by an optical multiplexer and is transmitted through the optical circulator to a receiving unit in a monitoring device.

Furthermore, a preferable mode is one wherein, in monitoring of a pair of the upward and downward optical transmission paths, a wavelength of the monitoring optical pulse used for monitoring the upward optical transmission path is different from that of the monitoring optical pulse used for monitoring the downward optical transmission path.

According to a second aspect of the present invention, there is provided an optical fiber amplification repeater for receiving and transmitting main signal light between optical wavelength multiplexing end ports in an optical amplification repeater system mounted, at an interval, on a pair of upward and downward optical transmission paths, comprising:

a pair of upward and down repeater circuits each having an optical fiber amplifier used to optically amplify output light obtained by multiplexing the main signal light and a monitoring optical pulse together, an optical circulator used to receive output light amplified by the optical fiber amplifier and to output the received light to an optical transmission path and an optical fiber grating used to transmit only backward scattering light of the monitoring optical pulse having a specified wavelength out of the backward scattering light which has reflected off a place of a failure in the optical transmission path, and has returned and which is to be output from the optical circulator, to an opposite optical transmission path through an optical path.

With the above configurations, since the optical fiber grating being able to make a reflection wavelength region narrow is used, it is made possible to propagate the monitoring optical component through the opposite optical transmission path without leaking of the main signal light having other different wavelength to the opposite optical transmission path and without degradation of transmission characteristics of the main signal light being transmitted through the opposite optical transmission path.

With another configuration as above, since the optical circulator is connected to an output port of the optical fiber amplifier, the loss in the backward scattering light generated by the monitoring optical pulse guided to the opposite optical transmission path can be reduced, thus enabling detection of abnormality of loss in the optical transmission path at high distance-resolution and in a short time even in a long repeating interval system.

With still another configuration as above, in-service optical transmission path monitoring with high accuracy can be implemented without the degradation of transmission characteristics of the main signal light.

### BRIEF DESCRIPTION OF THE DRAWINGS

The above and other objects, advantages and features of the present invention will be more apparent from the following description taken in conjunction with the accompanying drawings in which:

FIG. 1 is a schematic block diagram showing configurations of an optical amplification repeater system employing an optical transmission path monitoring device for wavelength division multiplexing transmission according to a first embodiment of the present invention;

FIG. 2 is a diagram explaining configurations and operations of an optical fiber amplification repeater in the optical amplification repeater system according to the first embodiment of the present invention;

FIG. 3 is a diagram explaining configurations and operations of an optical fiber amplification repeater in the optical amplification repeater system according to a second embodiment of the present invention; and

FIG. 4 is a schematic block diagram showing configurations of an optical amplification repeater system employing a conventional optical transmission path monitoring device.

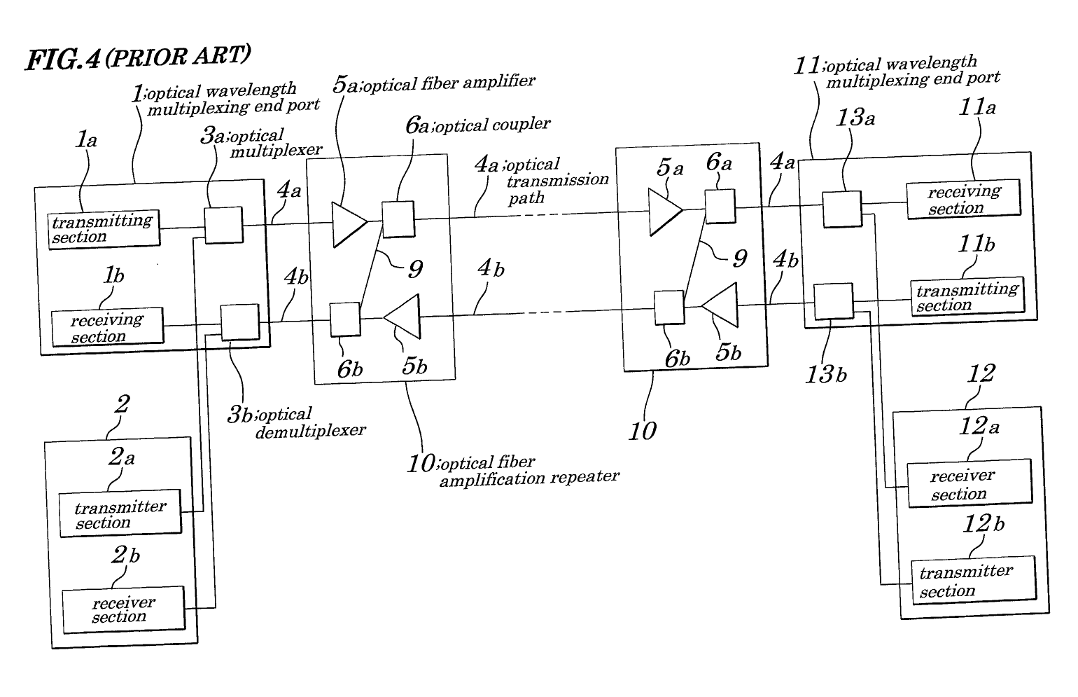

### DETAILED DESCRIPTION OF THE PREFERRED EMBODIMENTS

Best modes of carrying out the present invention will be described in further detail using various embodiments with reference to the accompanying drawings.

### First Embodiment

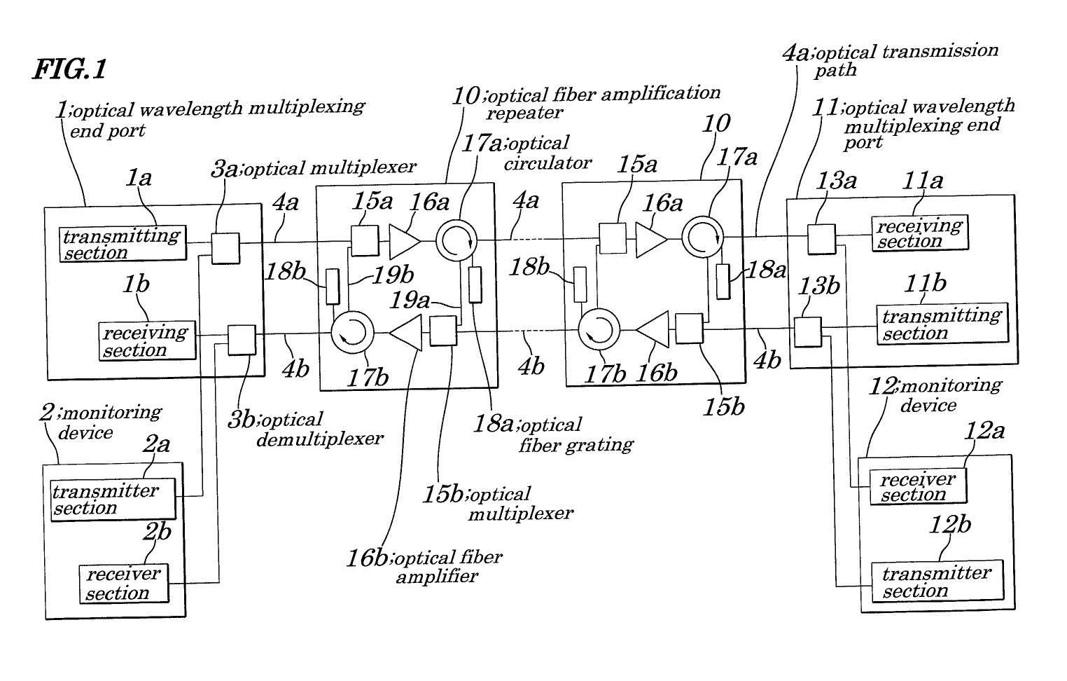

FIG. 1 is a schematic block diagram showing configurations of an optical amplification repeater system employing an optical transmission path monitoring device for wavelength division multiplexing transmission according to a first embodiment of the present invention.

In FIG. 1, an optical wavelength multiplexing end port 1 is connected to an optical wavelength multiplexing end port 11 with a pair of upward and downward optical transmission paths 4a and 4b and the pair of the upward and downward optical transmission paths 4a and 4b passes through two or more optical fiber amplification repeaters 10, 10, . . . , between the optical wavelength multiplexing end ports 1 and 11. A monitoring device 2 is used to monitor the upward optical transmission path 4a in the optical amplification repeater system, which is provided with a transmitter section 2a to transmit a monitoring optical pulse having a specified wavelength, a receiver section 2b to receive the monitoring optical pulse and a measuring section (not shown). Similarly, a monitoring device 12 is used to monitor the downward optical transmission path 4b in the optical amplification repeater system, which is provided with a transmitter section 12b to transmit a monitoring optical pulse having a specified wavelength, a receiver section 12a to receive the monitoring optical pulse and a measuring section (not shown).

Preferably, the wavelength of the monitoring optical pulse used for monitoring the upward optical transmission path 4a is different from that used for monitoring the downward optical transmission path 4b. This enables simultaneous monitoring of both the upward and downward optical transmission paths 4a, 4b. Moreover, by using the main signal light having a wavelength different from that of the monitoring optical pulse, an in-service monitoring is made possible.

The optical wavelength multiplexing end port 1 is made up of a transmitting section 1a to transmit main signal light, a receiving section 1b to receive the main signal light, an optical multiplexer 3a to multiplex the main signal light fed from the transmitting section 1a and the monitoring optical pulse fed from the transmitter section 2a of the monitoring device 2 together and to transmit the multiplexed light to the upward optical transmission path 4a to be monitored and an optical demultiplexer 3b to demultiplex multiplexed light to feed main signal light to the receiving section 1b and a monitoring light component to the receiver section 2b. Similarly, the optical wavelength multiplexing end port 11 is made up of a receiving section 11a to receive main signal light, a transmitting section 11b to transmit the main signal light, an optical multiplexer 13b to multiplex the main signal light fed from the transmitting section 11b and the monitoring optical pulse fed from the transmitter section 12b of the monitoring device 12 together and to transmit the multiplexed light to the downward optical transmission path 4b to be monitored and an optical demultiplexer 13a to demultiplex the multiplexed light to feed the main signal light to the receiving section 11a and monitoring light components to the receiver section 12a of the monitoring device 12.

Each of the optical fiber amplification repeaters 10, 10, . . . , is made up of, if classified roughly, an upward repeater circuit and a downward repeater circuit. The upward repeater circuit includes an optical multiplexer 15a used to multiplex output light obtained by multiplexing the main signal light fed from the optical multiplexer 3a in the optical wavelength multiplexing end port 1 and the monitoring optical pulse fed from the upward optical transmission path 4a together and backward scattering light (that is, a downward monitoring light component having a different wavelength) fed from an optical circulator 17b mounted in the opposite optical transmission path 4b, an optical fiber amplifier 16a used to amplify the multiplexed light fed from the optical multiplexer 15a and an optical circulator 17a used to receive light output from the optical fiber amplifier 16a and to transmit it to the upward optical transmission path 4a to be monitored and, at the same time, to guide backward scattering light fed from the upward optical transmission path 4a to an optical fiber grating 18a and to transmit only the monitoring optical components fed through the upward optical transmission path 4a to the optical multiplexer 15b mounted in the opposite optical transmission path 4b through an optical path 19a.

The downward repeater circuit includes an optical multiplexer 15b used to multiplex output light obtained by multiplexing the main signal light fed from the optical multiplexer 13b in the optical wavelength multiplexing end port 11 and the monitoring optical pulse fed from the downward optical transmission path 4b together and backward scattering light (that is, a downward monitoring light component having a different wavelength) fed from an optical circulator 17a mounted in the opposite upward optical transmission path 4a, an optical fiber amplifier 16b used to amplify the multiplexed light fed from the optical multiplexer 15b and an optical circulator 17b used to receive light output from the optical fiber amplifier 16b and to transmit it to the downward optical transmission path 4b to be monitored and, at the same time, to guide backward scattering light fed from the downward optical transmission path 4b to an optical fiber grating 18b and to transmit only monitoring optical components fed through the downward optical transmission path 4b to the optical multiplexer 15a mounted in the opposite upward optical transmission path 4a through an optical path 19b.

In the example, let it be assumed that the optical circulator 17a serving as a nonreciprocal device has four input/output ports. Moreover, since the wavelength of the monitoring optical pulse used for monitoring the upward optical transmission path 4a is different from that for the downward optical transmission path 4b, an output port of the optical fiber grating 18a in the upward optical transmission path 4a reflects the backward scattering light of the upward monitoring optical pulse and is adapted to terminate, without reflection, the backward scattering light of the downward monitoring optical pulse and the main signal light. Similarly, an output port of the optical fiber grating 18b in the downward optical transmission path 4b reflects backward scattering light of the downward monitoring optical pulse and is adapted to terminate, without reflection, the backward scattering light of the upward monitoring optical pulse and the main signal light.

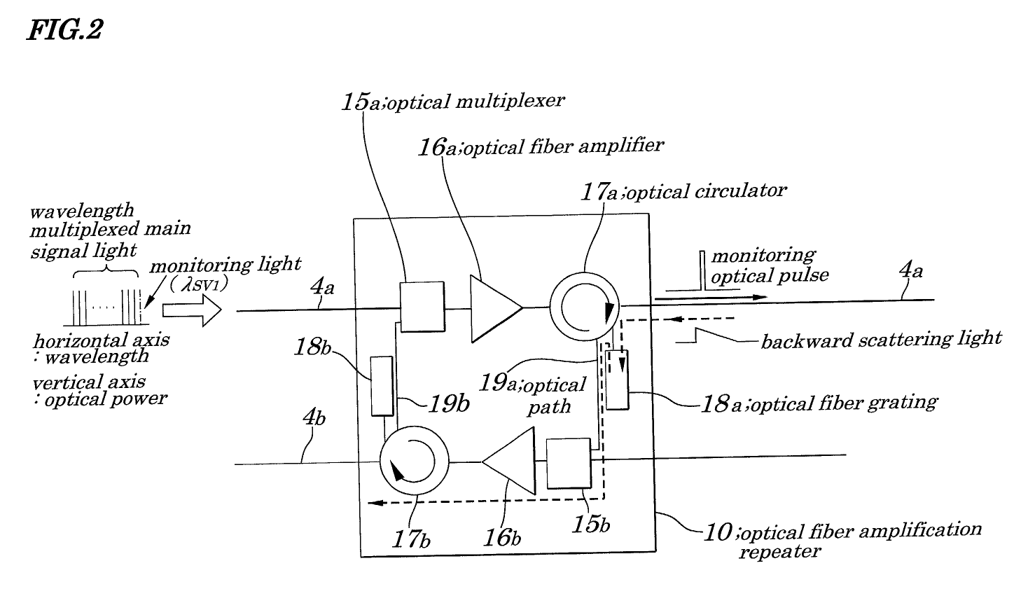

In-service operations for monitoring the upward optical transmission path 4a of the first embodiment will be described below by referring to FIG. 2. FIG. 2 is a diagram explaining configurations and operations of the optical fiber amplification repeater 10 in the optical amplification repeater system according to the first embodiment. In the example, the in-service monitoring is implemented by using the monitoring optical pulse whose wavelength is different from that of the main signal light. Moreover, though, by using the monitoring optical pulse used for monitoring the downward optical transmission path 4b having a wavelength being different from that of the monitoring optical pulse used for the upward optical transmission path 4a both the upward and downward optical transmission paths 4a, 4b can be simultaneously monitored, for convenience in explanation, the monitoring for the upward and downward transmission paths 4a 4b will be described in order.

The wavelength multiplexed main signal light fed from the transmitting section 1a and the monitoring optical pulse having a specified wavelength used for monitoring the upward optical transmission path 4a fed from the transmitter section 2a are multiplexed together by the optical multiplexer 3a in the optical wavelength multiplexing end port 1 and are transmitted through the upward optical transmission path 4a to the optical fiber amplification repeater 10. The optical multiplexer 15a in the optical fiber amplification repeater 10 multiplexes the multiplexed output light fed from the upward optical transmission path 4a and the backward scattering light (that is, a monitoring light component having a different wavelength) fed from the optical circulator 17b together and outputs the multiplexed light to the optical fiber amplifier 16a. The optical fiber amplifier 16a optically amplifies the multiplexed light so as to maintain it at a specified level and outputs the amplified light to a first port of the optical circulator 17a and the optical circulator 17a outputs the light fed from its second port to the upward optical transmission path 4a.

The backward scattering light generated in the main signal light and in the monitoring optical pulse from optical fibers, while the multiplexed light is passing through the upward optical transmission path 4a, returns back to the second port of the optical circulator 17a and are incident on the optical fiber grating 18a through a third port of the optical circulator 17a. The optical fiber grating 18a, by setting a reflection wavelength region to be narrow so that only the backward scattering light of the monitoring optical pulse with a predetermined wavelength transmitted in the upward optical transmission path 4a is reflected, operates to cause the backward scattering light of the main signal light and of the downward monitoring optical pulse to pass through the optical fiber grating 18a and to be dispersed by a non-reflection terminating section of the optical fiber grating 18a.

On the other hand, the backward scattering light of the monitoring optical pulse transmitted in the upward optical transmission path 4a is reflected off the optical fiber grating 18a and is incident on the third port of the optical circulator 17a and is output through its fourth port, an optical path 19a and the optical multiplexer 15b to the opposite downward optical transmission path 4b. Even if backward scattering light is further generated in the backward scattering light of the monitoring optical pulse being transmitted in the downward optical transmission path 4b, used for monitoring the upward optical transmission path 4a, since it is dispersed by the optical fiber grating 18b, newly-generated backward scattering light does not leak to the upward optical transmission path 4a.

The backward scattering light of the monitoring optical pulse having returned back to the optical wavelength multiplexing end port 1 through the opposite downward optical transmission path 4b is demultiplexed by the optical demultiplexer 3b and is received by the receiver section 2b of the monitoring device 2. By measuring, in the measuring section of the monitoring device 2, time elapsed between the transmission of the monitoring optical pulse by the transmitter section 2a and the receipt of the backward scattering light of the monitoring optical pulse by the receiver section 2b and/or a ratio of an output of the monitoring light pulse to that of the backward scattering light, a position of a failure and/or loss of light in the upward optical transmission path 4a can be detected.

The in-service operations for monitoring the downward optical transmission path 4b of the first embodiment will be described below by referring to FIG. 2. By using the monitoring optical pulse used for the downward optical transmission path 4b having a wavelength being different from that of the monitoring optical pulse used for the upward optical transmission path 4a, both the upward and downward optical transmission paths 4a, 4b can be simultaneously monitored.

The wavelength multiplexed main signal light fed from the transmitting section 11b and the monitoring optical pulse having a specified wavelength for monitoring the upward optical transmission path 4a fed from the transmitter section 12b are multiplexed together by the optical multiplexer 13b in the optical wavelength multiplexing end port 11 and are transmitted through the upward optical transmission path 4a to the optical fiber amplification repeater 10.

The optical multilexer 15b in the optical fiber amplification repeater 10 multiplexes the multiplexed output light fed from the downward optical transmission path 4b and the backward scattering light (that is, the upward monitoring light component having a different wavelength) transmitted in the upward optical transmission path 4a fed from the optical circulator 17a together and outputs the multiplexed light to the optical fiber amplifier 16b. The optical fiber amplifier 16b optically amplifies the multiplexed light so as to maintain it at a specified level and outputs the amplified light to the optical circulator 17b, which further outputs it the downward optical transmission path 4b.

The backward scattering light generated in the main signal light and the monitoring optical pulse from optical fibers, while the multiplexed light is passing through the downward optical transmission path 4b, returns back to the optical circulator 17b and are incident on the optical fiber grating 18b. The optical fiber grating 18b, by setting a reflection wavelength region to be narrow so that only the backward scattering light of the monitoring optical pulse with a predetermined wavelength transmitted in the downward optical transmission path 4b is reflected, operates to cause the backward scattering light of the main signal light and of the downward monitoring optical pulse to pass through the optical fiber grating 18b and to be dispersed by a non-reflection terminating section of the optical fiber grating 18b. On the other hand, the backward scattering light of the monitoring optical pulse transmitted in the downward optical transmission path 4b is reflected off the optical fiber grating 18b and is output through the optical path 19b and the optical multiplexer 15a to the opposite upward optical transmission path 4a. Even if backward scattering light is further generated in the backward scattering light of the monitoring optical pulse being transmitted in the upward optical transmission path 4a used for monitoring the downward optical transmission path 4b, since it is dispersed by the optical fiber grating 18b, the newly-generated backward scattering light does not leak to the downward optical transmission path 4b.

The backward scattering light of the monitoring optical pulse having returned back to the optical wavelength multiplexing end port 11 through the opposite upward optical transmission path 4a is demultiplexed by the optical demultiplexer 13a and is received by the receiver section 12a in the monitoring device 12. By measuring, in the measuring section of the monitoring device 12, time elapsed between transmission of the monitoring optical pulse by the transmitter section 12b and receipt of the backward scattering light of the monitoring optical pulse by the receiver section 12a and/or a ratio of an output of the monitoring light pulse to that of the backward scattering light, a position of a failure and/or loss of light in the downward optical transmission path 4b can be detected.

### Second Embodiment

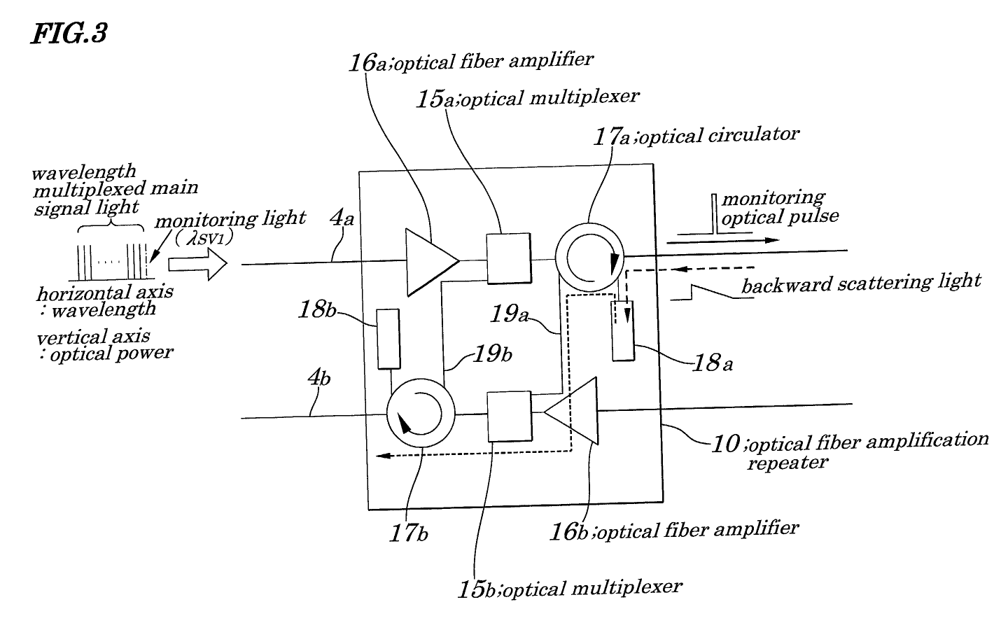

FIG. 3 is a diagram explaining configurations and operations of an optical fiber amplification repeater in the optical amplification repeater system according to a second embodiment of the present invention. In the second embodiment, as shown in FIG. 3, an optical fiber amplification repeater 10 is so configured that an optical multiplexer 15b mounted in an opposite downward optical transmission path 4b is connected to an output port of an optical circulator 17a mounted in an upward optical transmission path 4a and the optical multiplexer 15b is connected to an output of an optical fiber amplifier 16b. The optical fiber amplification repeater 10 has upward and downward repeater circuits made up of optical fiber amplifiers 16a and 16b, optical multiplexers 15a and 15b, optical circulators 17a and 17b, optical fiber gratings 18a and 18b and optical paths 19a and 19b in order.

The upward repeater circuit is made up of the optical fiber amplifier 16a used to receive main signal light and a monitoring optical pulse fed from the upward optical transmission path 4a and to amplify them, the optical multiplexer 15a used to receive outputs from the optical fiber amplifier 16a and the optical circulator 17a used to receive outputs from the optical multiplexer 15a and to output the light to the upward optical transmission path 4a positioned at the back to be monitored, to guide backward scattering light fed from the upward optical transmission path 4a to be monitored to the optical fiber grating 18a and to output only the monitoring optical pulse through the optical path 19a to the optical multiplexer 15b mounted in the opposite downward optical transmission path 4b. The optical circulator 17a has four input/output ports. An output port of the optical fiber grating 18a causes the backward scattering light of the monitoring optical pulse for monitoring the downward optical transmission path 4b and the main signal light to be terminated without reflection. Configurations of the downward repeater circuit are the same as those of the upward repeater circuit and their descriptions are omitted accordingly.

Thus, according to the second embodiment, substantially the same effects obtained in the first embodiment can be achieved.

It is apparent that the present invention is not limited to the above embodiments but may be changed and modified without departing from the scope and spirit of the invention. For example, in the above embodiments, the optical fiber grating is used as the optical demultiplexer, however, any device which can be equivalent in terms of functions to the optical fiber grating may be employed.

What is claimed is:

1. A method for monitoring optical transmission paths in an optical amplification repeater system in which main signal light is received and transmitted between optical wavelength multiplexing end ports through an optical fiber amplification repeater provided with upward and downward repeater circuits each having an optical fiber amplifier mounted in each of a pair of upward and downward optical transmission paths, said method comprising steps of:
mounting, on both of said optical wavelength multiplexing end ports, monitoring devices including, at least, a receiving unit and a transmitting unit used to receive and transmit a monitoring optical pulse to be multiplexed together with said main signal light;
mounting, on an output port of each of optical fiber amplifiers in said upward and downward repeater circuits, an optical circulator and an optical fiber grating;
guiding, by using said main signal light and said monitoring optical pulse transmitted from said optical circulator, backward scattering light generated while said main signal light and said monitoring optical pulse are propagating through said optical transmission path, to said optical fiber grating through said optical circulator; and
transmitting only backward scattering light of said monitoring optical pulse having a specified wavelength by using said optical fiber grating to an opposite optical transmission path.

2. The method for monitoring optical transmission paths in the optical amplification repeater system according to claim 1, wherein only a monitoring light component having a specified wavelength out of said backward scattering light is reflected off said optical fiber grating and a monitoring light component having other wavelength and said main signal light pass through said optical fiber grating and are dispersed by a non-reflection terminating section.

3. The method for monitoring optical transmission paths in the optical amplification repeater system according to claim 1, wherein said backward scattering light of said monitoring optical pulse output to an opposite optical transmission path is multiplexed together with said main signal light being transmitted through said opposite optical transmission path by an optical multiplexer mounted in said opposite optical transmission path and is transmitted through said optical fiber amplifier and said ptical circulator to said receiving unit in said monitoring device.

4. The method for monitoring optical transmission paths in the optical amplification repeater system according to claim 1, wherein said backward scattering light of said monitoring optical pulse output to said opposite optical transmission path is multiplexed together with said main signal light being transmitted in said opposite optical transmission path which has been amplified by an optical fiber amplifier mounted in said opposite optical transmission path by an optical multiplexer and is transmitted through said optical circulator to a receiving unit in a monitoring device.

5. The method for monitoring optical transmission paths in the optical amplification repeater system according to claim 1, wherein, in monitoring of a pair of said upward and downward optical transmission paths, a wavelength of said monitoring optical pulse used for monitoring said upward optical transmission path is different from that of said monitoring optical pulse used for monitoring said downward optical transmission path.

6. The method for monitoring optical transmission paths in the optical amplification repeater system according to claim 2, wherein said backward scattering light of said monitoring optical pulse output to an opposite optical transmission path is multiplexed together with said main signal light being transmitted through said opposite optical transmission path by an optical multiplexer mounted in said opposite optical transmission path and is transmitted through said optical fiber amplifier and said ptical circulator to said receiving unit in said monitoring device.

7. The method for monitoring optical transmission paths in the optical amplification repeater system according to claim 2, wherein said backward scattering light of said monitoring optical pulse output to said opposite optical transmission path is multiplexed together with said main signal light being transmitted in said opposite optical transmission path which has been amplified by an optical fiber amplifier mounted in said opposite optical transmission path by an optical multiplexer and is transmitted through said optical circulator to a receiving unit in a monitoring device.

8. The method for monitoring optical transmission paths in the optical amplification repeater system according to claim 2, wherein, in monitoring of a pair of said upward and downward optical transmission paths, a wavelength of said monitoring optical pulse used for monitoring said upward optical transmission path is different from that of said monitoring optical pulse used for monitoring said downward optical transmission path.

9. An optical fiber amplification repeater for receiving and transmitting main signal light between optical wavelength multiplexing end ports in an optical amplification repeater system mounted, at an interval, on a pair of upward and downward optical transmission paths, comprising:
a pair of upward and down repeater circuits each having an optical fiber amplifier used to optically amplify output light obtained by multiplexing said main signal light and a monitoring optical pulse together, an optical circulator used to receive output light amplified by said optical fiber amplifier and to output said received light to an optical transmission path and an optical fiber grating used to transmit only backward scattering light of said monitoring optical pulse having a specified wavelength out of said backward scattering light which has reflected off a place of a failure in said optical transmission path and has returned and which is to be output from said optical circulator, to an opposite optical transmission path through an optical path.
